(19) United States
(12) Patent Application Publication
(10) Pub. No.: US 2011/0219555 A1
(43) Pub. Date: Sep. 15, 2011

(54) CLEANING HEAD AND MOBILE FLOOR CLEANER

(75) Inventors: Bruce F. Field, Golden Valley, MN (US); Joseph L. Pouliot, Elk River, MN (US); Rick M. Pierce, Coon Rapids, MN (US)

(73) Assignee: TENNANT COMPANY, Minneapolis, MN (US)

(21) Appl. No.: 12/721,022

(22) Filed: Mar. 10, 2010

(51) Int. Cl. A47L 11/282; B43M 11/06

(52) U.S. Cl. 15/98; 401/261

(57) ABSTRACT

One embodiment of a cleaning head comprises a frame, a cylindrical member and a fluid output. The cylindrical member is supported by the frame for rotation about a central axis. The cylindrical member comprises a porous and compressible outer cylindrical wall. The fluid output is configured to dispense a liquid to an interior cavity of the cylindrical member. In one embodiment, a motor is not directly coupled to the cylindrical member for driving the rotation of the cylindrical member about the central axis. In accordance with another embodiment, the cleaning head includes an electrolysis cell within the cylindrical member. The electrolysis cell comprises first and second electrodes, each comprising porous layers of conductive material.

### FIELD OF THE INVENTION

One embodiment of the present invention is directed to a cleaning head for use in mobile floor cleaners and, more particularly, a cleaning head that is configured to have substantially rolling contact with a surface during the performance of a cleaning operation on the surface.

### BACKGROUND

Floor cleaning in public, commercial, institutional and industrial buildings have led to the development of various specialized floor cleaning machines, such as hard and soft floor cleaning machines. These cleaning machines generally utilize a cleaning liquid dispensing system and a cleaning head to perform a floor cleaning operation.

The cleaning liquid dispensing system generally dispenses a cleaning liquid that includes water and a chemically based detergent. The detergent typically includes a solvent, a builder, and a surfactant. While these detergents increase cleaning effectiveness for a variety of different soil types, such as dirt and oils, these detergents also have a tendency to leave unwanted residue on the cleaned surface. Such residue can adversely affect the appearance of the surface and the tendency of the surface to re-soil. Additionally, the detergents may not be environmentally friendly.

The cleaning head typically includes one or more scrubbing brushes, which may be located in front of, under or behind the floor cleaning machine. The scrubbing brushes typically include nylon bristles or fibers. The scrubbing brushes are motorized to rotate during cleaning operations. The rotation of the scrubbing brushes causes the brushes to scrub or scour the surface being cleaned as they engage the surface. However, such cleaning heads are not suitable for surfaces that would be subject to damage (e.g., scratching) from the scrubbing operation.

Improved floor cleaning heads, mobile floor cleaners, and floor cleaning methods are desired for reducing the use of detergents and/or reducing surface abrasion during cleaning operations, while maintaining the efficacy of the floor cleaning operation.

### SUMMARY

Embodiments of the invention are directed to a cleaning head and a mobile floor cleaner that includes the cleaning head. One embodiment of the cleaning head comprises a frame, a cylindrical member and a fluid output. The cylindrical member is supported by the frame for rotation about a central axis. The cylindrical member comprises a porous and compressible outer cylindrical wall. The fluid output is configured to dispense a liquid to an interior cavity of the cylindrical member. In one embodiment, a motor is not directly coupled to the cylindrical member for driving the rotation of the cylindrical member about the central axis. In accordance with another embodiment, the cleaning head includes an electrolysis cell within the cylindrical member. The electrolysis cell comprises first and second electrodes, each comprising porous layers of conductive material. One embodiment of the mobile floor cleaner includes a mobile body, a cleaning head, a cleaning liquid dispenser and a fluid recovery system. The mobile body is configured to travel over a surface in a forward direction during cleaning operations. The cleaning head includes a frame coupled to the mobile body and a cylindrical member supported by the frame for rotation about a central axis that is substantially parallel to the surface and perpendicular to the forward direction. The cylindrical member comprises a porous and compressible outer cylindrical wall and a rigid inner cylindrical wall supporting the outer cylindrical wall. The cleaning liquid dispenser comprises a fluid output configured to dispense a cleaning liquid to an interior cavity of the cylindrical member. The fluid recovery system comprises a squeegee coupled to a rear side of the cleaning head relative to the forward direction.

This Summary is provided to introduce a selection of concepts in a simplified form that are further described below in the Detailed Description. This Summary is not indented to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of a mobile floor cleaner in accordance with embodiments of the invention.

FIG. 2 is a simplified cross-sectional view of a cleaning head in accordance with embodiments of the invention.

FIGS. 3 and 4 are simplified diagrams of electrolysis cells in accordance with embodiments of the invention.

FIG. 5 is a front oblique view of a cleaning head in accordance with embodiments of the invention.

FIG. 6 is an exploded oblique view of the cleaning head of FIG. 5.

FIG. 7 is a side view of a portion of the cleaning head illustrated in FIG. 5.

FIG. 8 is a cross-sectional view of FIG. 7 taken generally along line 8-8.

FIG. 9 is a magnified view of the portion of FIG. 8 contained within the circle 9.

FIG. 10 is a cross-sectional view of an electrolysis cell in accordance with embodiments of the invention.

FIG. 11 is a flowchart illustrating a method of cleaning a surface in accordance with embodiments of the invention.

### DETAILED DESCRIPTION OF ILLUSTRATIVE EMBODIMENTS

The following description of illustrative embodiments of the invention will refer to the drawings described above. Elements having the same or similar reference number correspond to the same or similar elements.

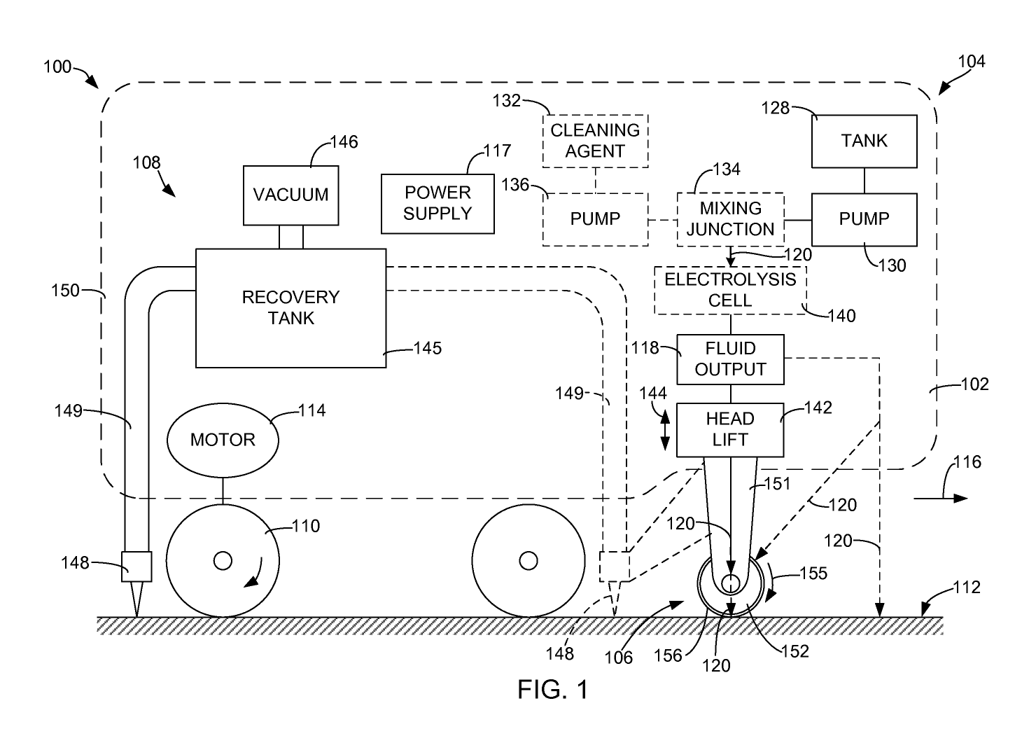

FIG. 1 is a simplified diagram of a mobile floor cleaner 100, in accordance with embodiments of the invention. The mobile floor cleaner 100 may be designed for use by an operator that walks behind the machine or rides on the machine. Alternatively, the mobile floor cleaner 100 may be designed to be towed behind a vehicle.

Embodiments of the cleaner 100 generally include a mobile body 102, a cleaning liquid dispenser 104, a cleaning head 106 and a fluid recovery system 108. The mobile body 102 is supported on wheels 110 for travel over a surface 112, on which a cleaning operation is to be performed. In one embodiment, at least one of the wheels 110 is driven by a motor 114 to propel the cleaner 100 in a forward direction, which is indicated by arrow 116. The motor 114 can also be configured to move the cleaner 100 in a rearward direction that is opposite the forward direction 116. One embodiment of the motor 114 is an electric motor powered by an onboard power supply 117 (e.g., one or more batteries) or through an electrical cord. In one embodiment, the motor 114 comprises an internal combustion engine.

The cleaning liquid dispenser 104 includes a fluid output 118 that is configured to dispense a cleaning liquid 120. In one embodiment, the fluid output 118 dispenses the cleaning liquid 120 either directly to the surface 112 and/or directly to a surface of the cleaning head 106, as indicated by the arrows in FIG. 1. In accordance with a preferred embodiment, the fluid output 118 is configured to deliver the cleaning liquid 120 to an interior cavity of the cleaning head 106, and dispense the cleaning liquid 120 to the surface 112 from within the cleaning head 106.

One embodiment of the cleaning liquid dispenser 104 includes a tank 128 and a pump 130, as shown in FIG. 1. In accordance with this embodiment, the tank 128 is filled with a desired cleaning liquid and the pump 130 drives a flow of the cleaning liquid from the tank to the fluid output 118 for dispensing. Alternatively, the cleaning liquid can be gravity fed, in which case the pump 130 can be eliminated.

Embodiments of the cleaning liquid 120 includes regular tap water containing no more than 1.0 moles per liter salt. In another embodiment, the aqueous composition contains no more than 0.1 moles per liter salt. An aqueous composition containing more than 1.0 moles per liter salt can be used in further embodiments. The term regular “tap water” means any water that is commonly available for home or commercial use, from public works, storage, wells, etc. Regular tap water (hereinafter “water”) typically contains salt at a concentration of less than 0.1 moles per liter. Deionized water or water in which the ionic content is negligible is less preferable since ions aid in the electrochemical activation of water, discussed below. In one embodiment, the cleaning liquid 120 consists of only water.

In accordance with another embodiment of the cleaning liquid dispenser 104, the tank 128 is filled with water and a separate supply of cleaning agent (i.e., surfactant) is provided, a flow of which is mixed with a flow of water from the tank 128 at a mixing junction 134 to form the desired cleaning liquid. In one embodiment, the dispenser 104 includes a pump 136 that drives the flow of cleaning agent 132 to the mixing junction 134, while the pump 130 drives the flow of water from the tank 128 to the mixing junction 134. The flows of cleaning agent and water are then mixed in the mixing junction 134, which outputs a flow of cleaning liquid 120, as illustrated in FIG. 1. Other configurations can also be used. For instance, the mixing junction 134 can include a venturi injector that is configured to inject the flow of cleaning agent into the flow of water making the pump 136 unnecessary.

One embodiment of the cleaning liquid dispenser 104 includes an electrolysis cell 140 that electrochemically activates the cleaning liquid 120, which is in the form of water or a combination of water and cleaning agent. The electrolysis cell 140 is supported on the mobile body 102 and formed in accordance with one or more of the embodiments described in U.S. patent application Ser. Nos. 11/655,365 and 12/488,360, both of which are incorporated herein by reference in their entirety.

One embodiment of the cleaner 100 includes a head lift 142 that is supported by the mobile body 102. The head lift 142 is configured to raise and lower the cleaning head 106 relative to the surface 112, as indicated by arrow 144. During transport, the head lift 142 raises the cleaning head 106 off the surface 112. During cleaning operations, the head lift 142 lowers the cleaning head 106 to engage the surface 112. In one embodiment, the head lift 142 is configured to adjust a pressure that is applied to the surface 112 by the cleaning head 106.

One embodiment of the fluid recovery system 108 includes a recovery tank 145, a vacuum 146 and a squeegee 148. These components may be referred to as a group as a “vacuum squeegee”. The squeegee 148 extends across the width of the cleaner 100 and collects liquid and particulate debris while engaging the surface 112 during cleaning operations. In one embodiment, the squeegee 148 is supported by the mobile body 102 and can be raised and lowered relative to the mobile body 102 and the surface 112. Tubing 149 connects the squeegee 148 to the recovery tank 145. In operation, the vacuum 146 generates a vacuum, such as within the recovery tank 145, which generates sufficient suction to remove the liquid waste collected by the squeegee 148 from the floor 112 and deposit the liquid waste in the recovery tank 145 through the tubing 149. The squeegee 148 is located downstream of the cleaning head 106 relative to the perceived movement of the surface 112 relative to the cleaner 100, as the cleaner 100 travels in the forward direction 116 during a cleaning operation. In one embodiment, the squeegee 148 is located at the rear end 150 of the cleaner 100, as illustrated in FIG. 1. In accordance with another embodiment, the squeegee 148 is attached to a frame 151 that supports the cleaning head 106, as illustrated in phantom lines in FIG. 1. In one embodiment, the squeegee 148 is located less than 20 inches from the cleaning head 106.

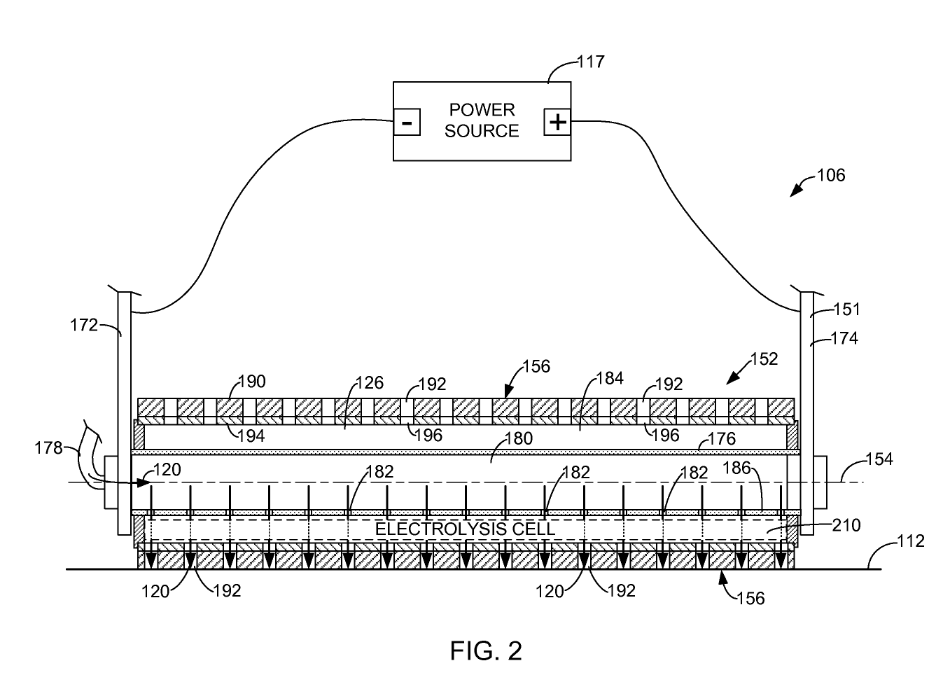

FIG. 2 is a simplified cross-sectional view of a cleaning head 106 in accordance with embodiments of the invention. In one embodiment, the cleaning head 106 is configured to dispense the cleaning liquid 120 to the surface 112 from within the interior of the cleaning head 106, as mentioned above. One embodiment of the cleaning head 106 includes a cylindrical member 152 that is configured to engage the surface 112 and rotate about a central axis 154, as indicated by arrow 155 (FIG. 1) during the performance of the cleaning operation on the surface 112.

In one embodiment, the rotation of the cylindrical member 152 is not directly driven by a motor. This non-motorized rotation of the cylindrical member 152 means that, unlike conventional floor cleaning heads, no motor is directly coupled to the cylindrical member 152 through a mechanical linkage of the cleaner, such as a drive belt or gear train, through which the rotation of the cylindrical member 152 about the axis 154 can be driven. Rather, the rotation of the cylindrical member 152 of the cleaning head 106 is driven solely by engagement of the cylindrical member 152 with the surface 112 as the mobile body 102 travels across the surface 112.

In accordance with some embodiments, the exterior surface 156 of the cylindrical member 152 is placed in rolling contact with the surface 112 during cleaning operations. Thus, unlike conventional floor cleaning heads that move relative to the surface they are engaging during cleaning operations, the relative horizontal motion (i.e., parallel to the surface 112) of the cylindrical member 152 and the surface 112 at the point of contact is zero. Thus, this embodiment of the cleaning head 106 is configured to perform a cleaning operation on the surface 112 substantially without abrasive (i.e., sliding or rubbing) contact with the surface 112. As a result, embodiments of the cleaning head 106 of the present invention are suitable for performing cleaning operations on delicate surfaces 112.

In one embodiment of the invention, the rotation of the cylindrical member 152 is partially driven by a motor (not shown) and the motion of the mobile body 102 relative to the surface 112. Here, the motor only drives rolling contact between the cylindrical member 152 and the surface 112. This motorized rotation of the cylindrical member 152 requires very little power as compared to the power required to drive the cylindrical member 152 in sliding or scrubbing engagement with the surface 112, in which the frictional resistance between the exterior surface 156 and the surface 112 must be overcome.

The elimination of a dedicated motor to rotate the cleaning head 106 results in significant energy savings. It is estimated that the cleaner 100 will utilize approximately 50% less power than corresponding floor cleaners utilizing motorized scrub heads. As a result, the cleaner 100 has a significantly longer operational run time than comparable floor cleaners of the prior art. Furthermore, the reduced power requirements of the cleaner 100 allow the cleaner 100 to be formed smaller and lighter due to its lower power requirements. For instance, the reduced power requirements of the cleaner 100 allow the cleaner 100 to include an onboard power supply 117 comprising fewer and/or smaller batteries than those of comparable floor cleaners of the prior art. This results in reduced weight of the cleaner 100, which further enhances its energy efficiency. The smaller size of the cleaner 100 relative to comparable cleaners of the prior art allows the cleaner 100 to perform cleaning operations in tighter spaces. Transportation and storage costs are also reduced relative to comparable floor cleaners of the prior art due to the lower weight and size of the cleaner 100. Additionally, the cleaner 100 utilizing the non-motorized cleaning head 106 also operates quieter than conventional floor cleaners because the cleaning head 106 is not directly driven by a motor and does not scrub the surface 112.

Conventional floor cleaners utilizing motorized scrub heads includes skirting around the scrub heads to prevent the spraying of the cleaning liquid outside of the path of the floor cleaner to prevent the contamination of surfaces outside of the path of the floor cleaner and to maintain the cleaning liquid beneath the cleaner for collection by the vacuumized squeegee. One embodiment of the floor cleaner 100 lacks such skirting surrounding the cleaning head 106. Such skirting is generally unnecessary due to the horizontal axis of rotation 154 of the cylindrical member 152, the non-motorized rotation of the cylindrical member 152 and the slow speeds at which the mobile body 102 travels over the surface 112. The movement of the cylindrical member 152 during cleaning operations avoids the spraying of the cleaning liquid and other debris common to motorized scrub heads and maintains the cleaning liquid beneath the floor cleaner 100 for collection by the squeegee 148. The elimination of the skirting around the cleaning head 106 simplifies access to the cleaning head 106, which may be necessary to adjust, repair or replace the cleaning head 106. Additionally, the elimination of the skirting allows one to visualize the cleaning operation being performed by the cleaning head 106.

As mentioned above, the cleaning head 106 is supported by a frame 151 and includes a cylindrical member 152 that is configured for rotation about a horizontal axis 154. One embodiment of the frame 151 includes support members 172 and 174 that support opposing ends of the cylindrical member 152.

In one embodiment, the fluid output 118 includes a dispenser tube 176 within the cylindrical member 152. Conduit 178 of the fluid output 118 delivers a flow of cleaning liquid 120 into the interior cavity 180 of the tube 176. In one embodiment, the fluid output 118 includes one or more apertures or slots 182 formed in the tube 176. The apertures 182 are preferably distributed along the length tube 176 to allow for substantially even dispensing of the cleaning liquid 120 to the interior cavity 184 of the cylindrical member 152. In one embodiment, the tube 176 does not rotate with the cylindrical member 152 about the axis 154. Rather, the tube 176 is attached to the support members 172 and 174 of the frame 151 such that the tube 176 does not rotate about the axis 154. In accordance with this embodiment, the apertures 182 are located at least on the bottom side 186 of the tube 176 and along the length of the tube 176.

In one embodiment, the tube 176 rotates with the rotation of the cylindrical member 152 about the axis 154. In accordance with this embodiment, the apertures 182 are preferably spread along the length of the tube 176 and around the circumference of the tube 176 to encourage even dispensing of the cleaning liquid 120 to the interior side 184 of the cylindrical member regardless of the angular position of the tube 176.

One embodiment of the cylindrical member 152 includes an outer cylindrical wall 190. In one embodiment the cylindrical wall 190 is formed of a porous and compressible material. In one embodiment, the material forming the outer cylindrical wall 190 is hydrophobic. Exemplary materials used to form the outer cylindrical wall 190 include foam, rubber and other suitable materials.

The porosity of the outer cylindrical wall 190 is preferably designed to provide the desired wetting of the surface 112. In one embodiment, the porosity of the outer cylindrical wall 190 is determined by the porosity of the material forming the wall 190. Alternatively, the porosity of the outer cylindrical wall 190 is engineered by the inclusion of apertures 192 in the wall 190. One embodiment of the apertures 190 are slots and/or bores through the wall 190, as illustrated in FIG. 2. The apertures 192 can be of varying shapes. In one embodiment, the apertures 192 are circular bores through the wall 190, as shown in FIG. 2.

The compressibility of the cylindrical wall 190 can agitate the surface 112 using the cleaning liquid without sliding contact with the surface 112. This occurs as the outer cylindrical wall 190 is first compressed against the surface 112 and then decompressed as the cylindrical member 152 rolls over the surface 112. The compression of the outer cylindrical wall 190 causes an initial increase in pressure within the apertures 192. This pressure is released when the cylindrical wall decompresses and expands as the cylindrical member 152 continues to rotate. This compression and decompression operation moves the cleaning liquid 120 proximate to the apertures 190, which encourage the release of dirt on the surface 112 for later collection by the downstream squeegee 148.

In one embodiment, the cylindrical member 152 includes an inner cylindrical wall 194. In one embodiment, the inner cylindrical wall 194 is rigid and provides support for the outer cylindrical wall 190. In one embodiment, the outer cylindrical wall 194 is formed of plastic (e.g., PVC) or metal. In one embodiment, the inner cylindrical wall 194 includes apertures 196 that are at least partially aligned with the apertures 192 of the outer wall 190. The apertures 196 may be larger than the apertures 192 or more numerous to ensure at least partial overlap or alignment with the apertures 192 of the outer cylindrical wall 190.

In one embodiment, the cylindrical member 152 is formed by placing the outer cylindrical wall 190 over the inner cylindrical wall 194. Holes can then be drilled through both the outer wall 190 and the inner wall 194 to form the apertures 192 and 196 in perfect alignment with each other. In accordance with another embodiment, the outer wall 190 and the inner wall 194 are formed separately, but are later assembled such that the apertures 192 and 196 are in substantial alignment with each other. In yet another embodiment, the inner cylindrical wall 194 is formed first and the outer cylindrical wall 190 is over-molded on the cylindrical wall 194. Other techniques for forming the cylindrical member 152 may also be used.

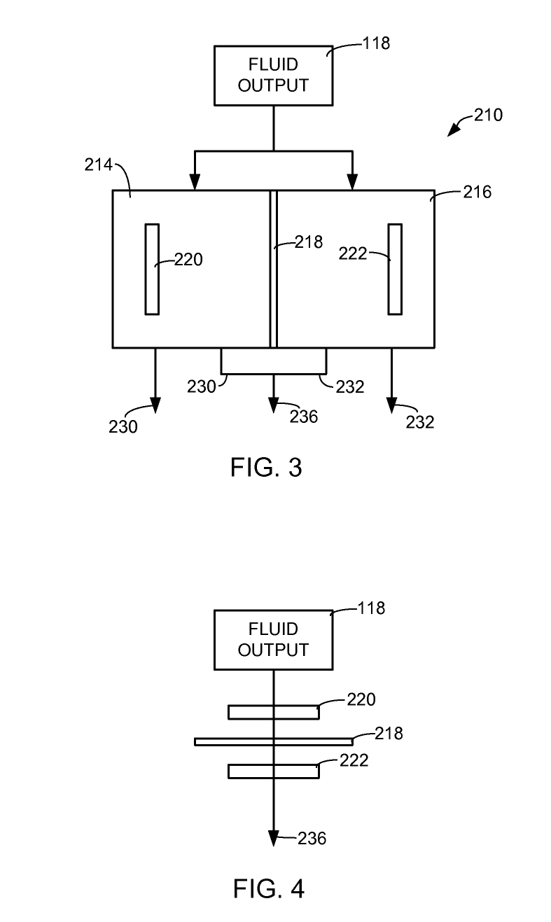

One embodiment of the cleaning head 106 includes an electrolysis cell 210 within the cylindrical member 152, as illustrated in FIG. 2. FIG. 3 is a simplified diagram of the electrolysis cell 210 in accordance with embodiments of the invention. In one embodiment, the cell 210 has one or more anode chambers 214 and one or more cathode chambers 216 (known as reaction chambers). In one embodiment, the cell 210 includes an ion exchange membrane 218, such as a cation or anion exchange membrane. One or more anode electrodes 220 and cathode electrodes 222 (one of each electrode shown) are disposed in each anode chamber 214 and each cathode chamber 216, respectively. The anode and cathode electrodes 220, 222 can be made from any suitable material, such as a conductive polymer, titanium and/or titanium coated with a precious metal, such as platinum, or any other suitable electrode material. The electrodes and respective chambers can have any suitable shape and construction. For example, the electrodes can be flat plates, coaxial plates, rods, or a combination thereof. Each electrode can have, for example, a solid construction or can have one or more apertures. In one example, each electrode is formed as a mesh. In addition, multiple cells 210 can be coupled in series or in parallel with one another, for example. Thus, embodiments of the cleaner include the electrolysis cell 210 alone, and in combination with the electrolysis cell 140 supported on the mobile body.

The electrodes 220, 222 are electrically connected to opposite terminals of the power supply 117. Ion exchange membrane 218, if present, is located between electrodes 220 and 222. The power supply 117 can provide a constant DC output voltage, a pulsed or otherwise modulated DC output voltage, and/or a pulsed or otherwise modulated AC output voltage to the anode and cathode electrodes. The power supply can have any suitable output voltage level, current level, duty cycle or waveform.

For example in one embodiment, the power supply 117 applies the voltage supplied to the plates at a relative steady state. The power supply includes a DC/DC converter that uses a pulse-width modulation (PWM) control scheme to control voltage and current output. Other types of power supplies can also be used, which can be pulsed or not pulsed and at other voltage and power ranges. The parameters are application-specific.

During operation, the cleaning liquid 120, which in the form of feed water or a combination of water and cleaning agent, is supplied from the fluid output 118 to both anode chamber 214 and cathode chamber 216. In the case of a cation exchange membrane, upon application of a DC voltage potential across anode 220 and cathode 222, such as a voltage in a range of about 5 Volts (V) to about 25V, cations originally present in the anode chamber 214 move across the ion-exchange membrane 218 towards cathode 222 while anions in anode chamber 214 move towards anode 220. However, anions present in cathode chamber 216 are not able to pass through the cation-exchange membrane, and therefore remain confined within cathode chamber 216. As a result, cell 210 electrochemically activates the cleaning liquid 120 by at least partially utilizing electrolysis and produces electrochemically-activated cleaning liquid, such as tap water, in the form of an acidic anolyte composition 230 and a basic catholyte composition 232.

If desired, the anolyte and catholyte can be generated in different ratios to one another through modifications to the structure of the electrolysis cell, for example. For example, the cell can be configured to produce a greater volume of catholyte than anolyte if the primary function of the electrochemically activated (EA) water is cleaning. Alternatively, for example, the cell can be configured to produce a greater volume of anolyte than catholyte if the primary function of the EA water is sanitizing. Also, the concentrations of reactive species in each can be varied. For example, the cell can have a 3:2 ratio of cathode plates to anode plates for producing a greater volume of catholyte than anolyte. Here, each cathode plate is separated from a respective anode plate by a respective ion exchange membrane. Thus, there are three cathode chambers for two anode chambers. This configuration produces roughly 60% catholyte to 40% anolyte. Other ratios can also be used.

As mentioned above, the ion exchange membrane 218 can include a cation exchange membrane (i.e., a proton exchange membrane) or an anion exchange membrane. Suitable cation exchange membranes for membrane 218 include partially and fully fluorinated ionomers, polyaromatic ionomers, and combinations thereof. Examples of suitable commercially available ionomers for membrane 218 include sulfonated tetrafluorethylene copolymers available under the trademark “NAFION” from E. I. du Pont de Nemours and Company, Wilmington, Del.; perfluorinated carboxylic acid ionomers available under the trademark “FLEMION” from Asahi Glass Co., Ltd., Japan; perfluorinated sulfonic acid ionomers available under the trademark “ACIPLEX” from Asahi Chemical Industries Co. Ltd., Japan; and combinations thereof However, any ion exchange membrane can be used in other examples.

In one example, the anolyte and catholyte outputs are blended into a common output stream 236, which is dispensed through the cylindrical member 252 to the surface 112. As described in U.S. Patent Publication No. 2007/0186368 (Field et al.), it has been found that the anolyte and catholyte can be blended together within the distribution system of a cleaning apparatus and/or on the surface or item being cleaned while at least temporarily retaining beneficial cleaning and/or sanitizing properties. Although the anolyte and catholyte are blended, they are initially not in equilibrium and therefore temporarily retain their enhanced cleaning and/or sanitizing properties.

FIG. 4 is a simplified diagram of the electrolysis cell 210 in accordance with another embodiment of the invention, in which the flow of the cleaning liquid 120 is modified from that shown in FIG. 3 by first directing the cleaning liquid through one of the anode or cathode electrodes 220, 222, through the membrane 218, and then through the other electrode. While FIG. 4 illustrates the flow of cleaning liquid 120 as traveling from the anode electrode 220 to the cathode electrode 222, it is understood that this flow of the cleaning liquid 120 can be reversed. The output 236 is dispensed through the cylindrical member 252. As discussed above, one embodiment of the electrolysis cell 210 of FIG. 4 does not include the ion exchange membrane 218 and operates as an oxygenator or sparging device, which generates fine gas bubbles in the cleaning liquid 120. The resulting cleaning liquid 120 facilitates an efficient wetting of the liquid 120 on the floor surface 112.

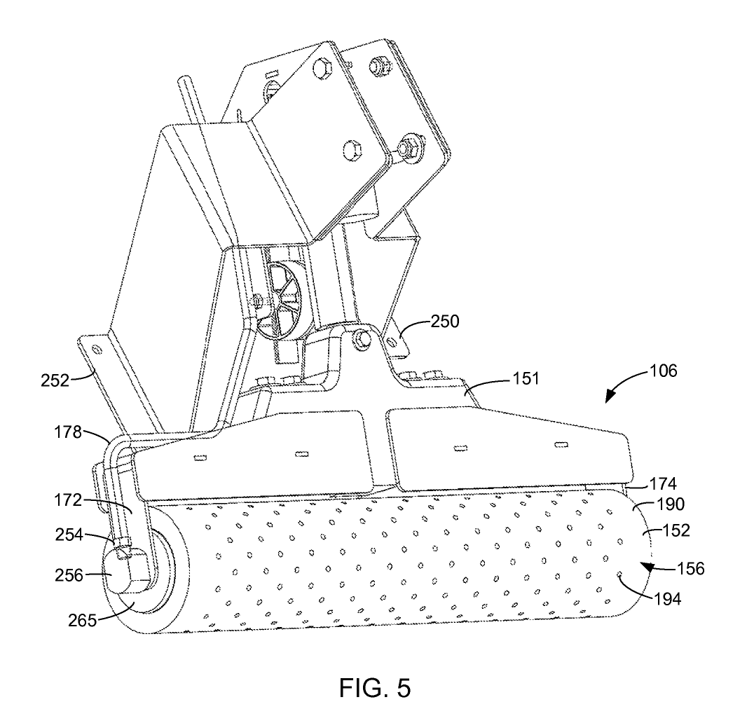

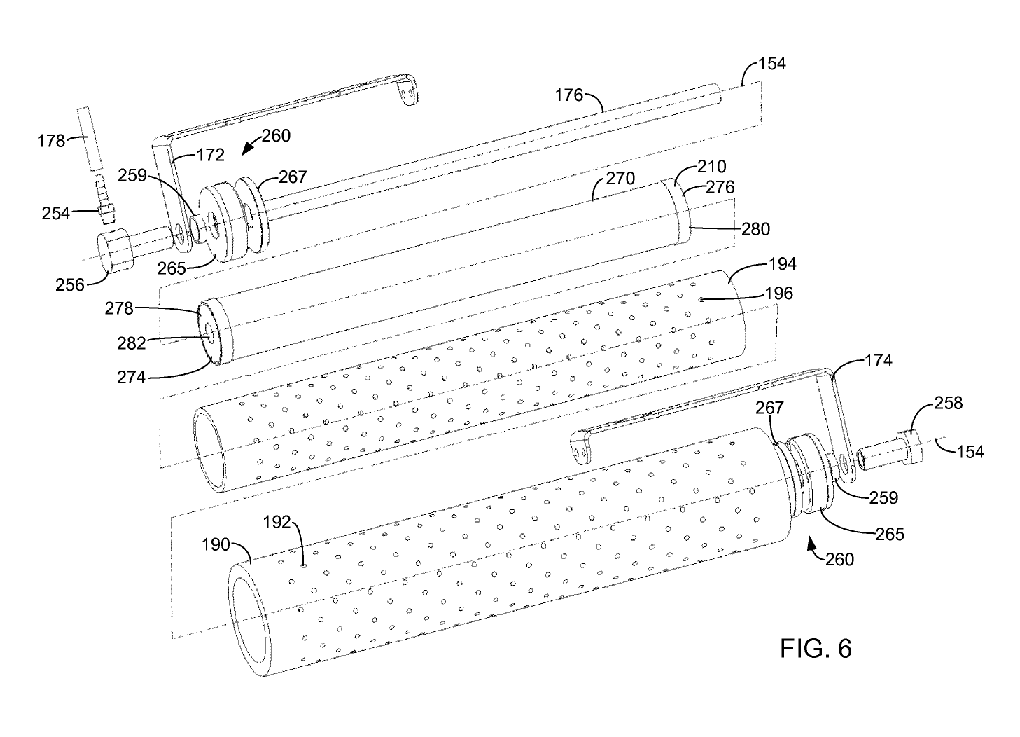

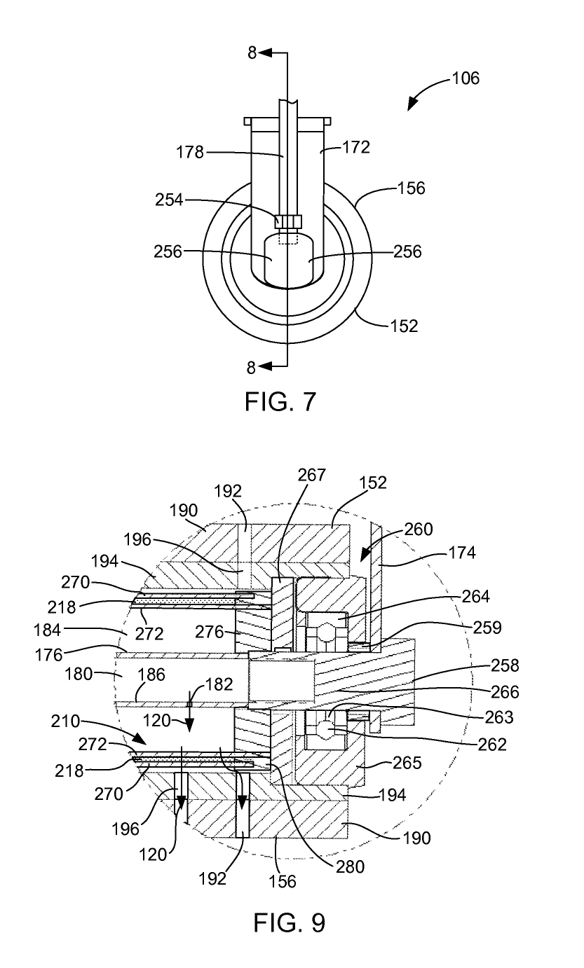

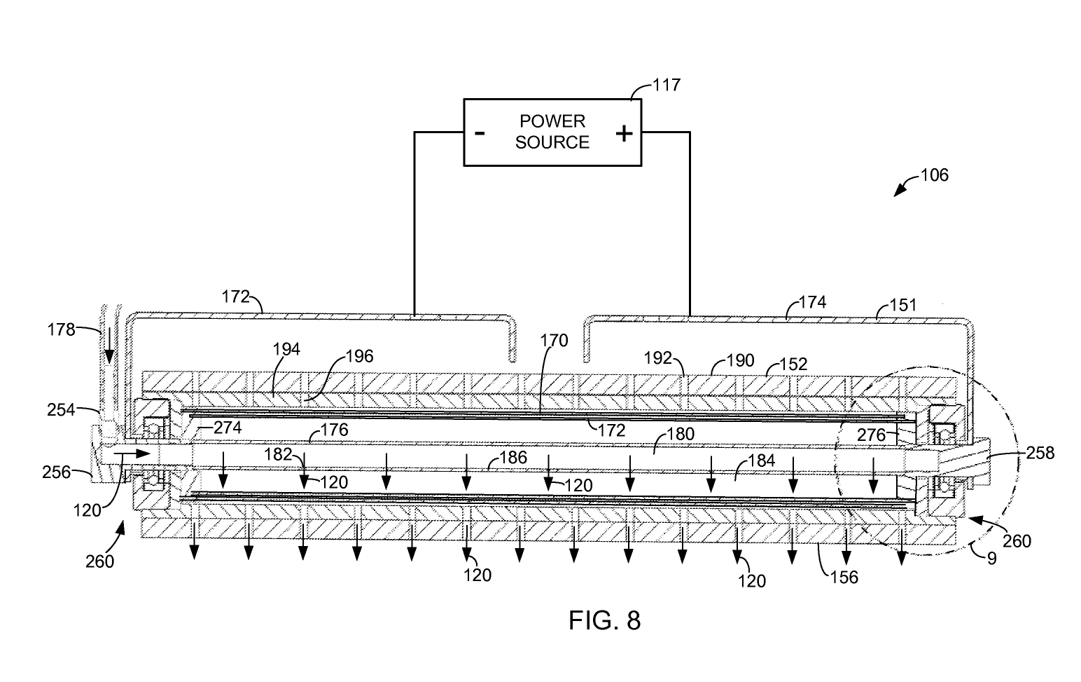

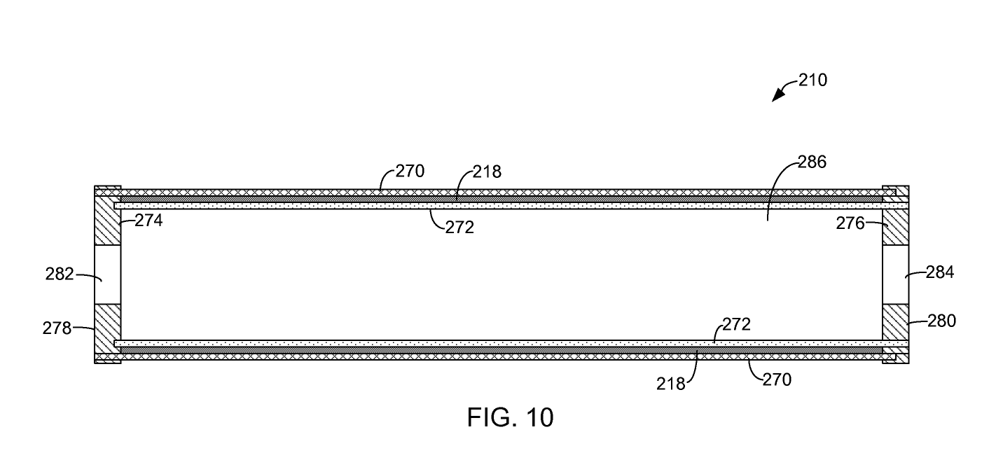

Additional embodiments of the cleaning head 106 will be described with reference to FIGS. 5-10. FIG. 5 is a front oblique view of a cleaning head 106 in accordance with embodiments of the invention. FIG. 6 is an exploded oblique view of the cleaning head of FIG. 5. FIG. 7 is a side view of a portion of the cleaning head 106 illustrated in FIG. 5. FIG. 8 is a cross-sectional view of FIG. 7 taken along line 8-8. FIG. 9 is a magnified view of the portion of FIG. 8 contained within the circle 9. FIG. 10 is a cross-sectional view of an electrolysis cell 210 in accordance with embodiments of the invention. As mentioned above, elements having the same or similar reference numbers as those described above correspond to the same or similar elements.

The frame 151 includes brackets, such as brackets 250 and 252 that are coupled to a frame of the mobile body 102. The tubing 178, through which the fluid output 118 delivers the cleaning liquid 120 to the cylindrical member 152, is coupled to a fitting 254. The fitting 254 is received by a hub member 256, which is supported by the member 172. The member 174 supports another hub member 258 on the opposing end of the cylindrical member 152. The hub members 256 and 258 define the central axis 154 about which the cylindrical member 152 rotates. The hub members 256 and 258 are secured to the members 172 and 174 by a nut 259 or other suitable method.

The ends of the tube 176 are attached to the hub members 256 and 258. In one embodiment, the ends of the tube 176 are secured to the hub members 256 and 258 such that tube 176 does not rotate about the axis 154.

A pair of bearing assemblies 260 are supported for rotation about the axis 254. In one embodiment, the bearing assemblies 260 comprise ball bearings 262, an inner race 263, an outer race 264, and an outer member 265, as shown in FIG. 9. The inner race 263 is supported on either the portions 266 of the hub members 256 and 258 (as shown) or on the tube 176. The outer member 265 is attached to the outer race 264 and the inner cylindrical wall 194 of the cylindrical member 152. A seal cap 267 seals the interior side of the assembly 260 at the interface with the portions 266 of the hub members 256 and 258. The seal cap 267 can also provide a seal at the interface with the inner cylindrical wall 194.

In one embodiment, the electrolysis cell 210 has a tubular shape and comprises a tubular outer electrode 270 and a tubular inner electrode 272, which is separated from the outer electrode by a suitable gap, such as about 0.040 inches, as illustrated in FIG. 10. Other gap sizes can also be used, such as, but not limited to gaps in the range of 0.020 inches to 0.080 inches. The inner and outer electrodes 270 and 272 each comprise a porous layer of conductive material, such as a conductive mesh. Either of the inner or outer electrodes 270 and 272 can serve as the anode electrode or the cathode electrode described above, depending upon the relative polarities of the applied voltages. In one embodiment, an ion exchange membrane 218 is positioned within the gap between the outer and inner electrodes 270 and 272. The membrane 218 can be formed in accordance with the embodiments described above. In one embodiment, the membrane 218 is tubular. The tubular outer and inner electrodes 270 and 272, and the tubular form of the ion exchange membrane 218, are coaxial to the central axis 154.

In one example, the electrodes 270 and 272 are formed of a metallic mesh, with regular-sized openings in the form of a grid. In one specific example, the mesh is formed of 0.023 inch diameter T316 stainless steel having a grid pattern of 20×20 grid openings per square inch. However, other dimensions, arrangements and materials can be used. For instance, at least one of the anode or cathode electrodes can be formed at least partially or wholly of a conductive polymer, such as those used for static dissipating devices. Examples of suitable conductive polymers are commercially available from RTP Company of Winona, Minn., USA. For example, the electrodes can be formed of a conductive plastic compound having a surface resistivity of 10⁰ to 10¹² ohm/sq, such as 10¹ to 10⁶ ohm/sq. However, electrodes having surface resistivities outside those ranges can also be used.

The mesh of the electrodes 270 and 272 can be regular-sized rectangular openings in the form of a grid, or openings or apertures in having other shapes, such as circular, triangular, curvilinear, rectilinear, regular and/or irregular. Curvilinear apertures have at least one curved edge. When injection molded, for example, the shapes and sizes of the apertures can be easily tailored to a particular pattern. However, these patterns can also be formed in metallic electrodes.

One embodiment of the electrolysis cell 210 includes end caps 274 and 276, which receive at least a portion of the ends of the outer and inner electrodes 270 and 272, as illustrated in FIG. 10. In one embodiment, the portion of the outer electrode 270 received by the end cap 274 extends proximate to an exterior side 278 of the end cap 274, while the portion of the inner electrode 272 received by the end cap 274 extends into the end cap 274 short of the exterior side 278. Similarly, the portion of the inner electrode 272 received by the end cap 276 extends to an exterior side 280 of the end cap 276, while the portion of the outer electrode 270 received by the end cap 276 does not extend proximate to the exterior side 280. The end caps 274 and 276 are preferably formed of a compressible material that forms a seal between the openings 282 and 284 and the tube 176.

Electrically conductive paths couple each of the terminals of the power supply 117 to one of the inner and outer electrodes 270 and 272. The conductive paths can take on any suitable form. In one embodiment, one of the electrically conductive paths electrically couples one of the terminals of the power supply 117 to the end of the inner electrode 272 that is exposed at, or located proximate to, the exterior side 280 of the end cap 276, and the other of the electrically conductive paths electrically couples the other terminal of the power supply 117 to the end of the outer electrode 170 that is exposed at, or located proximate to, the exterior side 278 of the end cap 274. In one embodiment, the electrically conductive path to the electrode 270 includes the support member 172 and the electrically conductive path to the electrode 272 includes the support member 174. Here, the support members 172 and 174 are electrically insulated from each other.

In one embodiment, the electrically conductive path from one of the terminals of the power supply 117 to the inner electrode 272 includes the support member 174, the hub member 258, the ball bearings 262, the race 264, and a conductive portion of the seal cap 267, such as the end of the electrode 272. Similarly, in one embodiment, the electrically conductive path from the other terminal of the power supply 117 to the outer electrode 270 includes the support member 172, the hub 256, the ball bearings 262, the race 264, and a conductive portion of the seal cap 267, such as the end of the electrode 270.

The end caps 274 and 276 respectively include openings 282 and 284 through which the tube 176 extends. The apertures 182 of the tube 176 are located within the interior cavity 286 of the cell 210. Thus, when the cleaning liquid 120 is dispensed through the tube 176, the cleaning liquid 120 travels through the apertures 182 of the tube 176, through the inner electrode 272, through the ion exchange membrane 218 (if present), through the outer electrode 272, as illustrated in FIGS. 2, 8 and 9. The electrochemically activated cleaning liquid 120 then travels through the apertures 192 and 196 of the cylindrical member 152 to the surface 112.

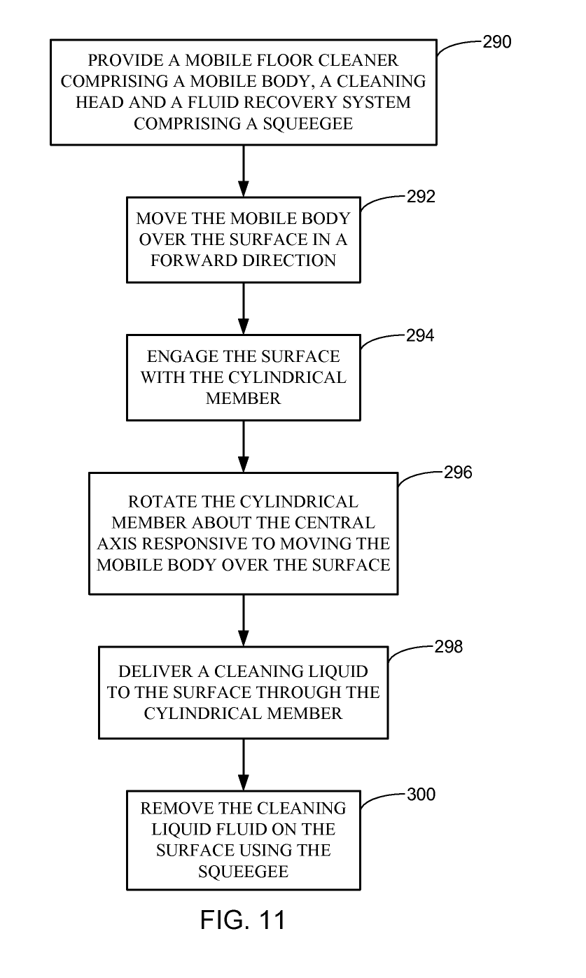

Additional embodiments of the invention are directed to a method of cleaning a surface using the mobile floor cleaner 100 or the cleaning head 106 formed in accordance with the embodiments described above. FIG. 11 is a flowchart illustrating such a method in accordance with embodiments of the invention. At 290, a mobile floor cleaner 100 is provided that includes a mobile body 102, a cleaning head 106 and a fluid recovery system 108 comprising a squeegee 148, in accordance with embodiments of the invention described above. In one embodiment, the cleaning head 106 includes a frame 151 and a cylindrical member 152 supported by the frame for rotation about a central axis 154. Next, at 292, the mobile body 102 is moved over the surface 112 in a forward direction 116 (FIG. 1) and the cylindrical member 152 engages the surface, at 294. The cylindrical member 152 is then rotated in the direction 155 (FIG. 1) about the central axis 154 responsive to moving the mobile body 102 over the surface 112, at 296. At 298, a cleaning liquid is dispensed to the surface 112 through the cylindrical member 152. At 300, the cleaning liquid on the surface 112 is removed using the fluid recovery system 108.

In one embodiment, the cleaning head further comprises an electrolysis cell 210 and the method comprises electrochemically activating the cleaning liquid prior to delivering the cleaning liquid to the surface 112 through the cylindrical member 152.

In accordance with one embodiment, the cylindrical member 152 of the cleaning head 106 includes a compressible outer cylindrical wall 190 and the method comprises compressing the outer cylindrical wall 190 against the surface 112 during the rotation of the cylindrical member 152 about the central axis 154 responsive to moving the mobile body 102 over the surface 112. In one embodiment, the rotation of the cylindrical member 152 about the central axis 154 is non-motorized.

Although the present invention has been described with reference to preferred embodiments, workers skilled in the art will recognize that changes may be made in form and detail without departing from the spirit and scope of the invention.

What is claimed is:

1. A cleaning head comprising:
a frame;
a cylindrical member supported by the frame for rotation about a central axis, the cylindrical member comprising a porous and compressible outer cylindrical wall; and
a fluid output configured to dispense a liquid to an interior cavity of the cylindrical member;
wherein a motor is not directly coupled to the cylindrical member for driving the rotation of the cylindrical member about the central axis.

2. The cleaning head of claim 1, wherein:
the cylindrical member further comprises a rigid inner cylindrical wall supporting the outer cylindrical wall, the inner cylindrical wall comprising a plurality of apertures; and
the inner and outer cylindrical walls are coaxial.

3. The cleaning head of claim 2, wherein the outer cylindrical wall comprises a plurality of apertures.

4. The cleaning head of claim 1, further comprising a squeegee attached to the frame.

5. The cleaning head of claim 1, wherein the fluid output comprises a dispenser tube within the cylindrical member having a plurality of apertures, the dispenser tube distributes cleaning liquid over a length of the cylindrical member along the central axis.

6. The cleaning head of claim 1, further comprising an electrolysis cell within the cylindrical member, the electrolysis cell comprising first and second electrodes, the electrodes each comprising porous layers of conductive material, wherein liquid dispensed from the fluid output travels through the first and second electrodes.

7. The cleaning head of claim 6, wherein the electrodes rotate with the rotation of the cylindrical member.

8. The cleaning head of claim 7, wherein the electrodes are tubular electrodes.

9. The cleaning head of claim 6, wherein:
the frame comprises first and second support members configured to support opposing ends of the cylindrical member, the first and second support members being electrically insulated from each other; and
the head further comprises:
a first electrically conductive path to the first electrode comprising the first support member; and
a second electrically conductive path to the second electrode comprising the second support member.

10. The cleaning head of claim 6, wherein the electrolysis cell includes an ion exchange membrane between the first and second electrodes.

11. A cleaning head comprising:
a frame;
a cylindrical member supported by the frame for rotation about a central axis, the cylindrical member comprising a porous and compressible outer cylindrical wall;
a fluid output configured to dispense a liquid to an interior cavity of the cylindrical member; and
an electrolysis cell within the cylindrical member, the electrolysis cell comprising first and second electrodes, the electrodes each comprising porous layers of conductive material.

12. The cleaning head of claim 11, wherein the first and second electrodes are tubular electrodes.

13. The cleaning head of claim 12, wherein the first and second electrodes rotate with the rotation of the cylindrical member.

14. The cleaning head of claim 11, wherein a motor is not directly coupled to the cylindrical member for driving the rotation of the cylindrical member about the central axis.

15. A mobile floor cleaner comprising:
a mobile body configured to travel over a surface in a forward direction during cleaning operations;
a cleaning head comprising:
a frame coupled to the mobile body; and
a cylindrical member supported by the frame for rotation about a central axis that is substantially parallel to the surface and perpendicular to the forward direction, the cylindrical member comprising a porous and compressible outer cylindrical wall and a rigid inner cylindrical wall supporting the outer cylindrical wall;
a cleaning liquid dispenser comprising a fluid output configured to dispense a cleaning liquid to an interior cavity of the cylindrical member;
a fluid recovery system comprising a squeegee coupled to a rear side of the cleaning head relative to the forward direction.

16. The cleaner of claim 15, wherein:
the fluid output comprises a dispenser tube within the cylindrical member having a plurality of apertures; and
the dispenser tube is configured to distribute cleaning liquid over a length of the cylindrical member along the central axis.

17. The cleaner of claim 15, further comprising an electrolysis cell within the cylindrical member, the electrolysis cell comprising first and second electrodes, the electrodes each comprising porous layers of conductive material, wherein cleaning liquid dispensed from the fluid output travels through the first and second electrodes.

18. The cleaner of claim 17, wherein the electrodes are tubular and rotate with the rotation of the cylindrical member.

19. The cleaner of claim 17, wherein:
the cleaner comprises an electrical power supply;
the frame comprises first and second support members configured to support opposing ends of the cylindrical member, the first and second support members being electrically insulated from each other; and
the cleaner further comprises:
a first electrically conductive path from the power supply to the first electrode comprising the first support member; and
a second electrically conductive path from the power supply to the second electrode comprising the second support member.

20. The cleaner of claim 17, wherein:
rotation of the cylindrical member about the central axis is non-motorized; and
the cylindrical member rotates in response to engagement with the surface and movement of the mobile body over the surface.
